(19) United States
(12) Patent Application Publication
(10) Pub. No.: US 2021/0051567 A1
(43) Pub. Date: Feb. 18, 2021

(54) RADIO ACCESS NETWORK FEATURE SET EXTENSION IN MEDIUM ACCESS CONTROL

(71) Applicant: QUALCOMM Incorporated, San Diego, CA (US)

(72) Inventors: Miguel GRIOT, La Jolla, CA (US); Gavin Bernard HORN, La Jolla, CA (US); Rajat PRAKASH, San Diego, CA (US)

(21) Appl. No.: 16/991,662

(22) Filed: Aug. 12, 2020

Related U.S. Application Data
(60) Provisional application No. 62/887,460, filed on Aug. 15, 2019.

(51) Int. Cl. H04W 48/08; H04W 8/24

(52) U.S. Cl. CPC H04W 48/08; H04W 8/24

(57) ABSTRACT

A method of wireless communication by a receiving device includes receiving a message by the receiving device from a transmitting device. The method further includes identifying a type of the message based on a message header of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field.

### CROSS REFERENCE TO RELATED APPLICATION(S)

This application claims the benefit of U.S. Provisional Application Ser. No. 62/887,460, entitled “RADIO ACCESS NETWORK FEATURE SET EXTENSION IN MEDIUM ACCESS CONTROL” and filed on Aug. 15, 2019, which is expressly incorporated by reference herein in its entirety.

### BACKGROUND

The present disclosure relates generally to wireless communication systems, and more particularly, to a radio access network (RAN) feature set extension for use in a medium access control (MAC) protocol layer.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, methods, computer-readable mediums, and apparatuses are provided.

In an aspect, a method of wireless communication by a receiving device includes receiving a message by the receiving device from a transmitting device. The method further includes identifying a type of the message based on a message header of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field.

In another aspect, a method of wireless communication by a transmitting device includes generating a message having a message header that identifies a type of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field. The method further includes transmitting the message having the message header, by the transmitting device to a receiving device.

In a further aspect, a receiving device for wireless communication includes a memory and at least one processor coupled with the memory. The at least one processor is configured to receive a message by the receiving device from a transmitting device. The at least one processor is further configured to identify a type of the message based on a message header of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field.

In yet another aspect, a transmitting device for wireless communication includes a memory and at least one processor coupled with the memory. The at least one processor is configured to generate a message having a message header that identifies a type of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field. The at least one processor is further configured to transmit the message having the message header, by the transmitting device to a receiving device.

In a further aspect, an apparatus for wireless communication includes means for receiving a message by a receiving device from a transmitting device. The apparatus further includes means for identifying a type of the message based on a message header of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field.

In yet another aspect, an apparatus for wireless communication includes means for generating a message having a message header that identifies a type of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field. The apparatus further includes means for transmitting the message having the message header, by a transmitting device to a receiving device.

In a further aspect, a non-transitory computer-readable medium stores computer executable code. The computer executable code, when executed by a processor, causes the processor to receive a message by a receiving device from a transmitting device. The computer executable code, when executed by the processor, further causes the processor to identify a type of the message based on a message header of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field.

In another aspect, a non-transitory computer-readable medium stores computer executable code. The computer executable code, when executed by a processor, causes the processor to generate a message having a message header that identifies a type of the message. The message header includes an identifier field of a determined length. The identifier field includes an identifier associated with the type of the message. The identifier is selected from a set of identifier values including one or more identifier values that fully identify the type of the message and one or more extension field inclusion values that indicate an inclusion of an extension field of the identifier field. The computer executable code, when executed by the processor, further causes the processor to transmit the message having the message header, by a transmitting device to a receiving device.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

Some further example implementations are provided below.

An example method of wireless communication by a receiving device, comprising: receiving a message by the receiving device from a transmitting device; and identifying a type of the message based on a message header of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field.

An example method of wireless communication by a transmitting device, comprising: generating a message having a message header that identifies a type of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field; and transmitting the message having the message header, by the transmitting device to a receiving device.

Any of the above methods of wireless communication, wherein each of the one or more extension field inclusion values indicates a set of message types.

Any of the above methods of wireless communication, wherein the extension field includes an extension identifier selected from a set of extension identifier values.

Any of the above methods of wireless communication, wherein the set of extension identifier values includes one or more extension identifier values that each, together with the identifier, fully identify the type of the message.

Any of the above methods of wireless communication, wherein the set of extension identifier values includes one or more subsequent extension field inclusion values that indicate a further inclusion of a subsequent extension field of the extension field of the identifier field.

Any of the above methods of wireless communication, wherein each of the one or more subsequent extension field inclusion values indicates a set of message types.

Any of the above methods of wireless communication, wherein the receiving device is a user equipment (UE) and the transmitting device is a base station.

Any of the above methods of wireless communication, wherein the transmitting device is a user equipment (UE) and the receiving device is a base station.

A device for wireless communication, including a memory storing instructions; and at least one processor coupled with the memory and configured to execute the instructions to perform the operations of any of the above methods of wireless communication.

An apparatus for wireless communication, including means for performing the operations of any of the above methods of wireless communication.

A computer-readable medium including storing computer executable code, the computer executable code, when executed by a processor, causes the processor to perform the operations of any of the above methods of wireless communication.

### BRIEF DESCRIPTION OF THE DRAWINGS

FIG. 1 is a diagram of an example of a wireless communications system and an access network, including at least one user equipment (UE) and at least one base station, each having a respective radio access network (RAN) feature set (RFS) extension component configured to perform RFS extension, in accordance with various aspects of the present disclosure.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a block diagram of an example protocol stack for RFS extension used by different entities or services in the wireless communication system, in accordance with various aspects of the present disclosure.

FIG. 4 is a diagram of a first example addressing space, in accordance with various aspects of the present disclosure.

FIG. 5 is a diagram of a second example addressing space, in accordance with various aspects of the present disclosure.

FIG. 6 is a diagram of a first example of medium access control (MAC) sub-header formats, in accordance with various aspects of the present disclosure.

FIG. 7 is a diagram of a second example of MAC sub-header formats, in accordance with various aspects of the present disclosure.

FIG. 8 is a diagram of an example packet data convergence protocol (PDCP) duplication, in accordance with various aspects of the present disclosure.

FIG. 9 is a diagram of a third example of MAC sub-header formats, in accordance with various aspects of the present disclosure.

FIG. 10 is a diagram of a third example addressing space, in accordance with various aspects of the present disclosure.

FIG. 11 is a block diagram of example components of the UE and the base station of FIG. 1 communicating in an access network, in accordance with various aspects of the present disclosure.

FIG. 12A is a flowchart of a first example method of wireless communication by a UE or a base station, in accordance with various aspects of the present disclosure.

FIG. 12B is a flowchart of a second example method of wireless communication by a UE or a base station, in accordance with various aspects of the present disclosure.

FIG. 13 is a block diagram of example components of the UE of FIG. 1, in accordance with various aspects of the present disclosure.

FIG. 14 is a block diagram of example components of the base station of FIG. 1, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G New Radio (NR), the concepts described herein may be applicable to other similar areas, such as Long Term Evolution (LTE), LTE Advanced (LTE-A), code division multiple access (CDMA), Global System for Mobile Communications (GSM), and other wireless technologies.

Aspects of the present disclosure allow for extending a logical channel identifier (LCID) field of a medium access control (MAC) protocol header in a hierarchical manner by defining one or more LCID values to indicate a radio access network (RAN) feature set (RFS) extension associated with one or more characteristics, e.g., a Third Generation Partnership Project (3GPP) release, a vertical set of feature or message types, etc. A vertical set of feature or message types may refer to a deployment of a specific set of features or messages that have protocol impacts across different layers of the protocol stack (e.g., MAC, radio resource control (RRC), etc.), such as may be associated with different industries, businesses, communication scenarios, etc., such as but not limited to the industrial Internet of Things (IoT) (e.g., in an assembly line), vehicle-to-other device (V2X), etc. In one non-limiting aspect, for example, one extra octet may be provided for RFS extension. Additional features of the present aspects are described in more detail below with respect to the appended drawings.

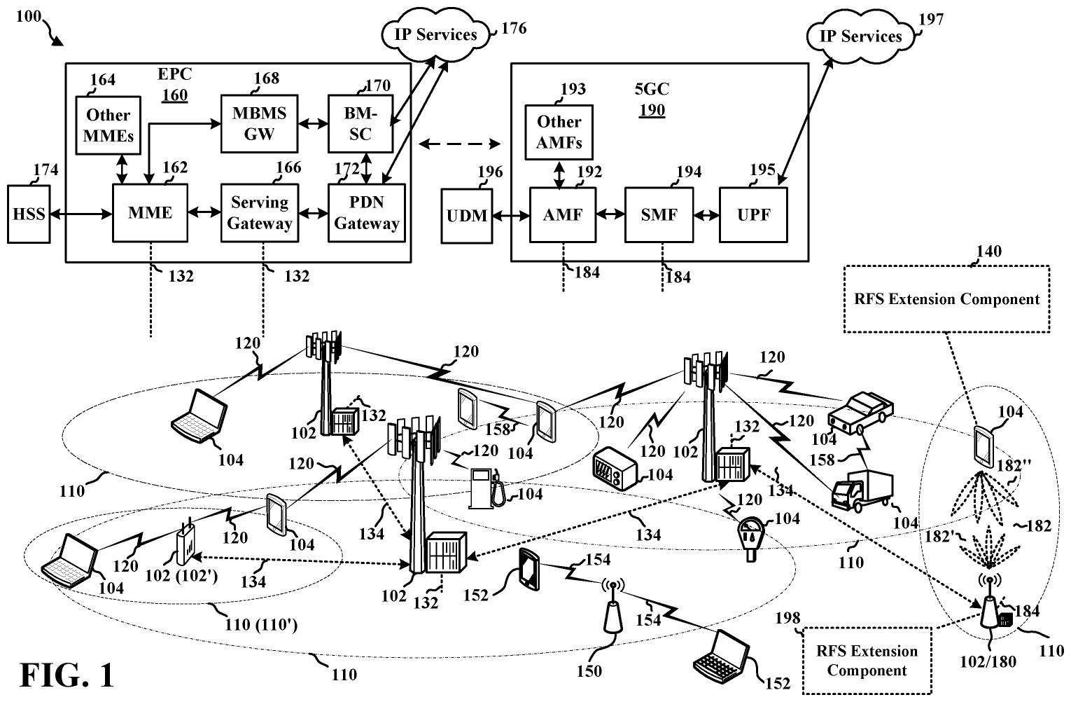

Referring to FIG. 1, in accordance with various aspects of the present disclosure, an example wireless communications system and access network 100 includes a user equipment (UE) 104 having an RFS extension component 140 and a base station 102 (e.g., a gNB) having an RFS extension component 198 to implement RFS extension functionality for communication between the UE 104 and the base station 102. Further details of the operation of the RFS extension component 140 of the UE 104 and the RFS extension component 198 of the base station 102 are described below with reference to the appended drawings.

The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., Si interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, and 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, e.g., including synchronization signals. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same (e.g., 5 GHz, or the like) unlicensed frequency spectrum as may be used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include an eNB, gNodeB (gNB), or another type of base station. Some base stations, such as gNB 180 may operate in a traditional sub-6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

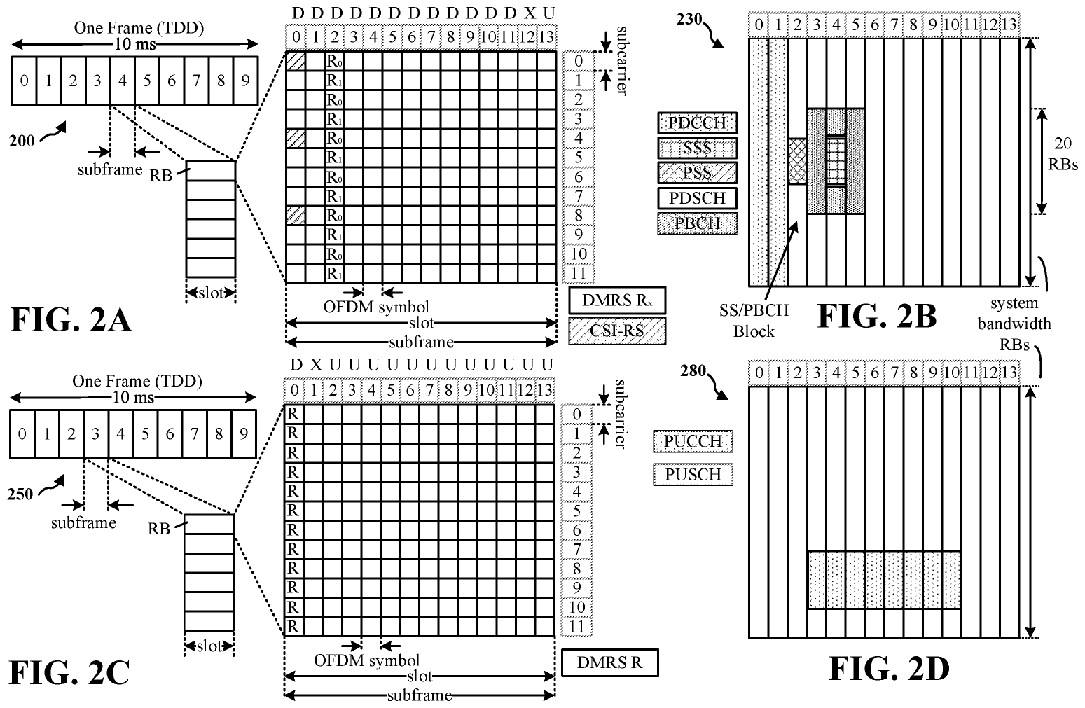

Referring to FIGS. 2A-2D, one or more example frame structures, channels, and resources may be used for communication between the base stations 102 and the UEs 104 of FIG. 1. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some aspects, signaling extensions and features (e.g., those motivated by verticals) may become “centralized” (e.g., defined as part of the general protocols/signaling), thus affecting the overall system.

As 5G is applied to different businesses, the need for specialized networks and specialized functionalities increases (e.g., in industrial IoT (e.g., an assembly line), automotive, public safety, augmented reality (AR), virtual reality (VR), gaming, etc.), with each solution corresponding to a different vertical requiring a specific messaging. Such functionalities may involve the expertise of different players that are not necessarily familiar with the 3GPP standardization process.

As 5G diverges into various businesses, the potential for localized operator-specific or deployment-specific messaging optimizations may increase. However, 3GPP RAN working groups (WGs) define the signaling formats, which may prevent operator-specific or deployment-specific messaging functionalities that are signaled within the protocols (e.g., MAC, PDPC) in a standards compliant manner.

In Rel-16, for example, some RAN enhancements for Industrial IoT are specific to that vertical and do not necessarily apply to other NR/5G system deployments.

Accordingly, aspects of the present disclosure enable a modular protocol-specific signaling framework for providing various features in the RAN that allow for creating an RFS extension to RAN protocols, where RFS “tags” (e.g., identifiers (IDs)) may be assigned to specific verticals (e.g., specific industries, business models, etc.) and specialized features.

Some aspects provide a mechanism for delegation of feature definition and message format to specialized groups. Accordingly, these aspects allow for faster and more seamless participation of different industry experts. Further, these aspects allow for introduction of operator-specific or deployment-specific messaging features.

Some aspects introduce specific features at different network elements/protocols without impacting other network elements.

Some aspects isolate testing and feature interactions to only the related RFS to reduce testing requirements and cost of devices.

Optionally, some aspects define one or more reserved RFS “tags” that may be used for operator-specific or deployment-specific message formats.

Some aspects provide localized extensions. For example, in an aspect, RFS extensions are provided at each logical RAN node independently. Accordingly, simpler deployment is provided (e.g., so as to localize the impact of each feature). Further, multi-node features are introduced at RRC (e.g., as in multi-layer features).

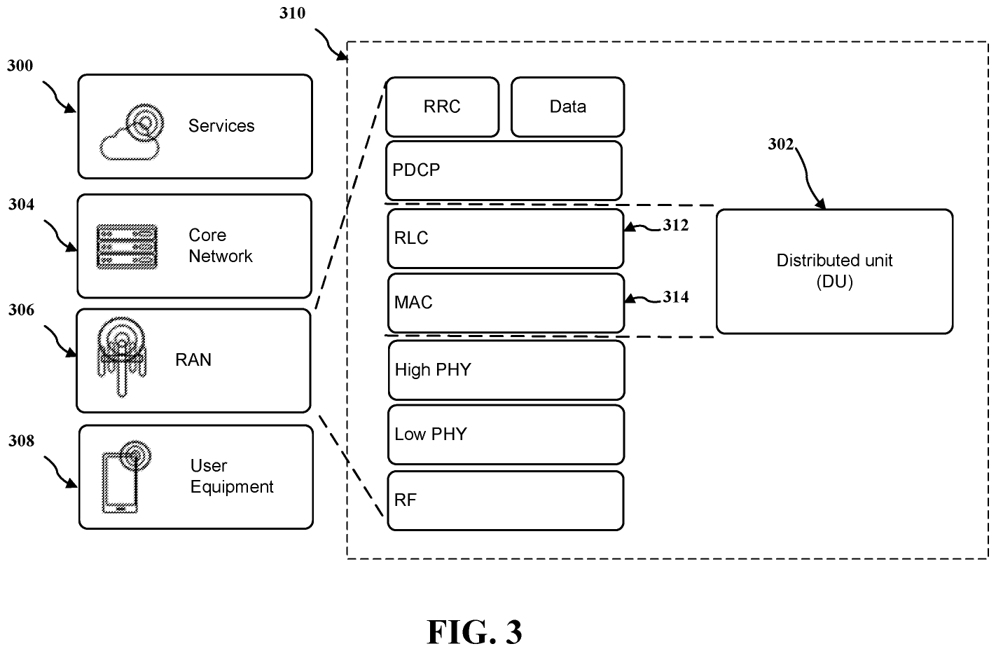

Referring to FIG. 3, an example implementation of services 300 or wireless entities (e.g., core network 304, RAN 306, UE 308, etc.) using protocol layers for communication may provide reserved bits/information elements (IEs) for extensions in layer 3 (L3) and/or layer 2 (L2), e.g., the radio link control (RLC) 312 and/or MAC layer 314, of the protocol stack 310 specifically for use by at least the RAN 306. For example, in one non-limiting aspect, a distributed unit (DU) 302 may utilize MAC control element (CE) formats, e.g., dynamic RLC legs configuration for industrial IoT.

An aspect provides addressing space for RFS extension.

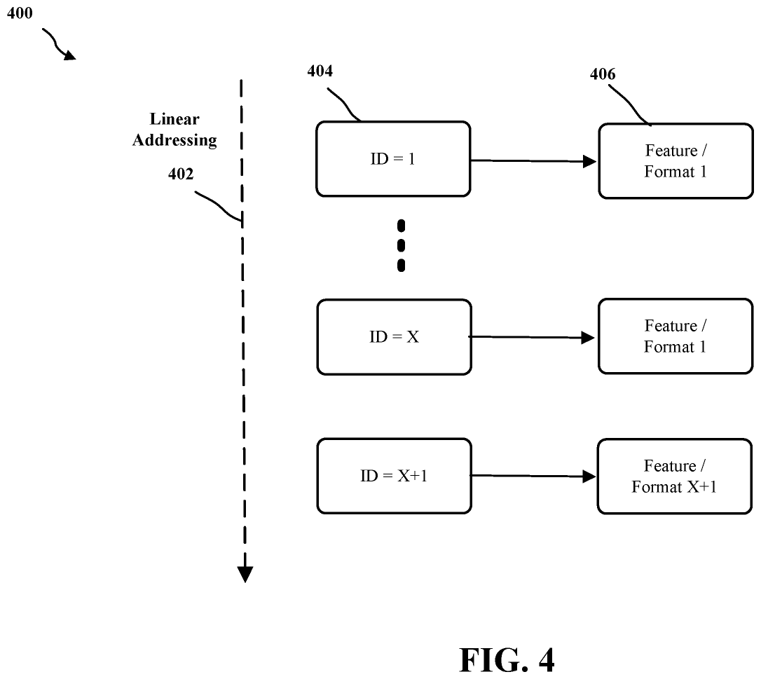

Referring to FIG. 4, in one aspect of 3GPP, an example addressing space 400 includes a flat addressing (e.g., linear addressing 402) that is implemented where one field is used for identifying a feature or message type. In an aspect, for example, the field may be an identifier (ID) field 404 that includes a value, where different values map to different specific features or formats 406. For example, for MAC, MAC service data unit (SDU) formats may be identified by an LCID value, e.g., from 0 to 63.

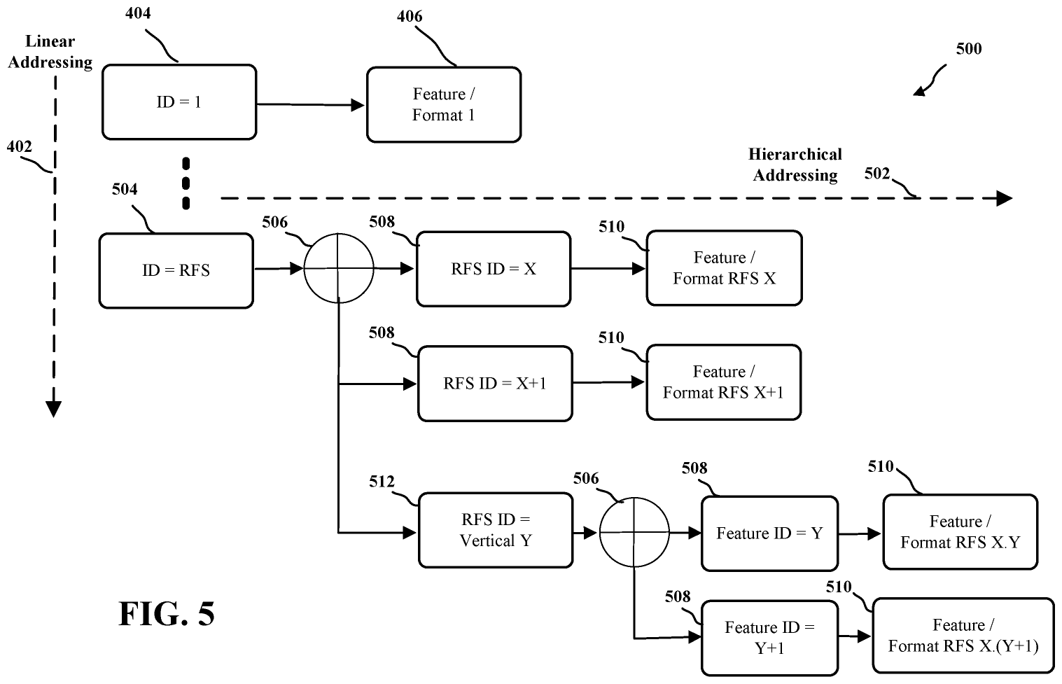

In contrast, referring to FIG. 5, an example addressing space 500 in a modular RFS approach may additionally or alternatively include hierarchical addressing 502. For example, the RFS approach may have an LCID with some IDs 404 that point to a specific feature or format 406, as well as some RFS IDs 504 that branch out 506 (extend) to an RFS ID 508 that in turn points to a specific feature or format 510, or to some further RFS IDs 512 that branch out 506 likewise. Accordingly, hierarchical addressing 502 is provided including two or more levels of hierarchy. In an aspect, one or more of the RFS IDs may be selected from LCID values that are not assigned to a specific format or feature.

Some aspects may provide a MAC sub-header addressing space for RFS extension.

In an aspect, for example, MAC CE formats are identified by the LCID.

In some MAC sub-headers, the LCID size is 6 bits, allowing for a maximum of 64 values, of which the values “0-32” are used for common control channel (CCCH) and identity of the logical channel, and the value “63” is used for padding. In DL-SCH, there are 15 LCID values defined in Rel-15 (values 47-62) corresponding to different MAC CE formats in DL, leaving 14 values available (33-46). In UL-SCH, there are 11 LCID values defined in Rel-15 (values 52-62) corresponding to different MAC CE formats in UL, leaving 19 values available (33-51).

As 5G use cases and scenarios (including verticals such as industrial IoT, C-V2X, etc.) have requirements that keep increasing, more RAN feature specific MAC formats may be needed to provide efficient functionalities to address such specialized requirements.

Some non-limiting optional aspects provide MAC CE formats that include one or more or a combination of the following functionalities (for example, to indicate to a receiving device how to act on a packet, how to configure a lower layer such as the physical layer (e.g., which physical layer feature to turn on or off), etc.). In the downlink, there may be one or more or a combination of: (1) MAC CE for PDCP duplication leg selection (e.g., for Industrial IoT), (2) timing advance MAC CE (e.g., for 2-step RACH), (3) enhanced TCI states activation/deactivation for UE-specific PDSCH MAC CE (e.g., for MIMO), (4) beam index indication MAC CE (e.g., for MIMO, for example, which beamforming/antenna configuration to use dynamically), (5) transmission configuration indicator (TCI) state indication for UE-specific PDCCH MAC CE (e.g., for MIMO, for example, whether to use TCI state or not), and/or (6) PUCCH spatial relation activation/deactivation MAC CE (e.g., for MIMO). Alternatively or additionally, in the uplink, there may be one or more or a combination of: (1) enhanced configured grant (CG) confirmation (e.g., for industrial IoT), and/or (2) MAC CE for indicating traffic changes (e.g., for power saving).

In an aspect, for example, the above functionalities may cause a configuration change in a receiving device until a subsequent MAC CE is received to further change such a configuration.

In an aspect, a base station may use one or more or a combination of the above functionalities to configure a UE responsive to a negotiated capability of the UE during RRC configuration when the UE establishes a radio bearer and connects to the base station.

In some aspects, the LCID field in MAC sub-header may run out of available values, for example, for DL-SCH, in later releases. For example, only 14 LCID values in DL-SCH and 19 LCID values in UL-SCH are available from Rel-15, and there may be multiple additional MAC CE formats (e.g., potentially up to 5 in DL-SCH and 2 in UL-SCH) in Rel-16. Thus, some aspects extend the LCID value space in MAC sub-header.

Some aspects extend the MAC sub-header to increase the LCID value space of Rel-16. Further, some aspects identify which additional MAC CE formats should be defined with the extended LCID value space in Rel-16 (and later releases), e.g., MAC CEs that are not likely to be used frequently, or that apply to a specific scenario or vertical. Further, some aspects identify that additional MAC CE formats should be defined without the extended LCID value space in Rel-16 (and later releases), e.g., because of the additional overhead due to expected frequent use of the additional MAC CE.

Accordingly, some aspects provide RFS extension in MAC CE.

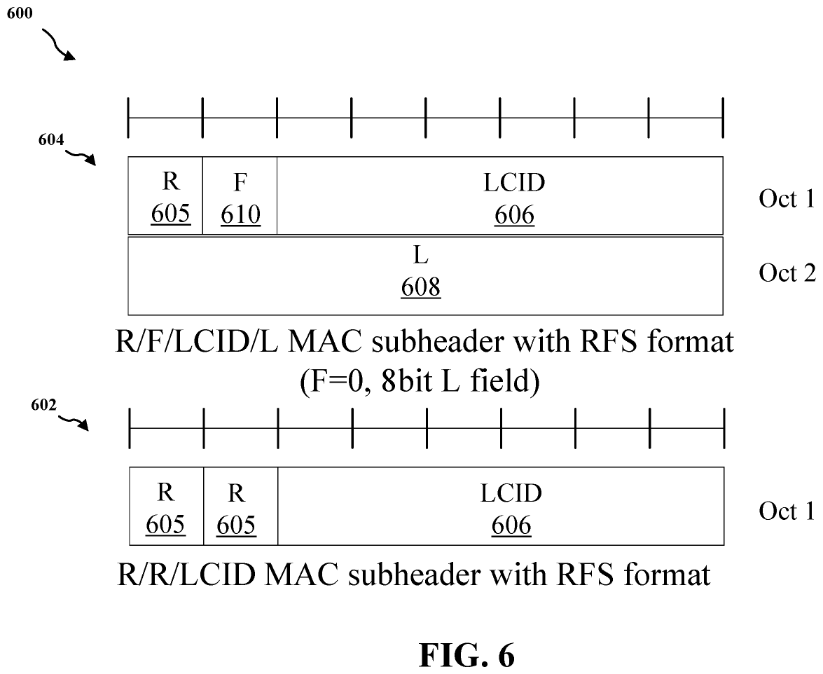

Referring to FIG. 6, in some example MAC formats 600, an R/R/LCID MAC sub-header with RFS format 602 includes reserved fields R 605 and an LCID field 606, while an R/F/LCID/L MAC sub-header with RFS format 604 includes reserved field R 605, LCID field 606, a length field L 608, and a format field F 610 indicating the size of the length field L 608. In some aspect, each type of message is assigned an LCID.

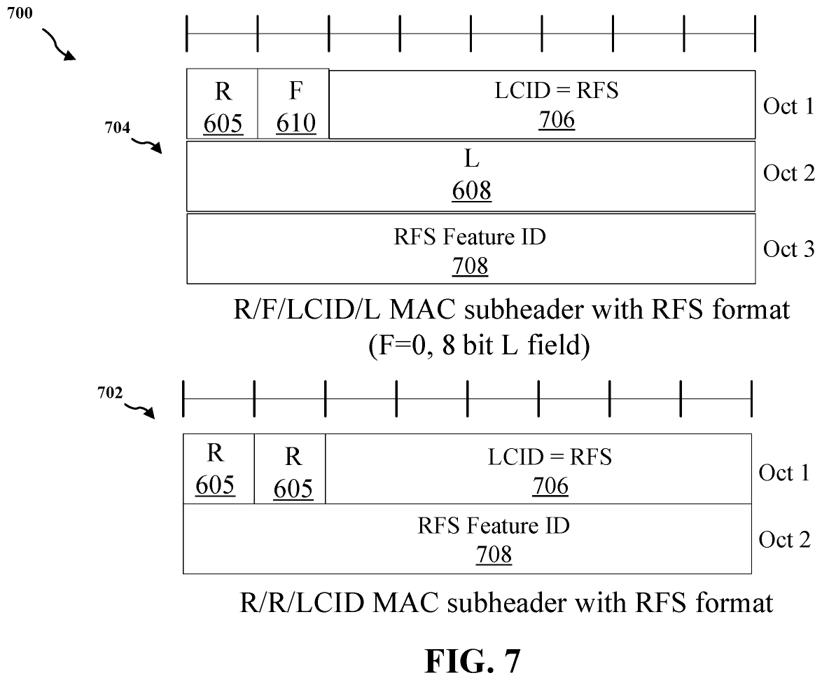

However, referring to FIG. 7, some aspects provide RFS MAC CE formats 700. Specifically, in this aspect, an R/R/LCID MAC sub-header with RFS format 702 or an R/F/LCID/L MAC sub-header with RFS format 704 has an LCID 706 in octet 1, where one LCID value (or a set of LCID values) is assigned for the RFS. In an aspect, for example, such an LCID value indicates: (1) the presence of another value field indicating the RFS feature ID 708; and (2) the feature or format is identified based on the LCID 706 and the RFS feature ID 708. For example, in an aspect, if the LCID 706 is equal to an RFS value, then the octet after L (e.g., octet 3 if F=0) includes the RFS specific feature ID 708.

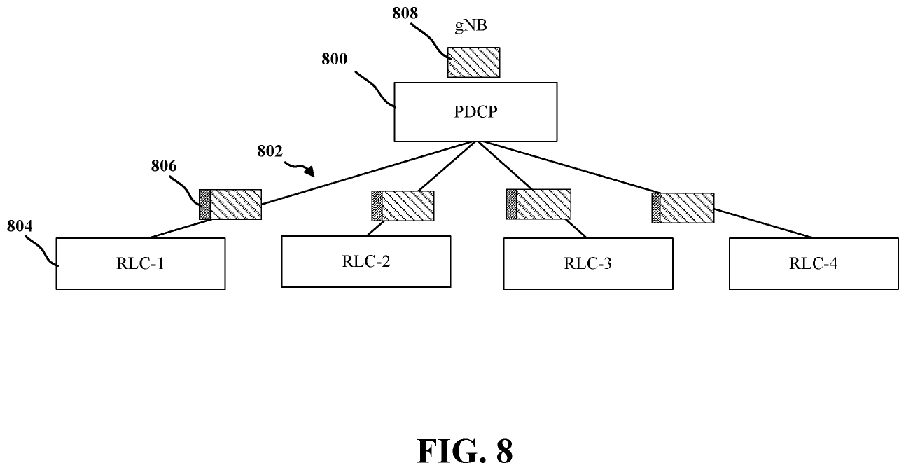

One example non-limiting aspect provides RFS extension in MAC CE for industrial IoT, e.g., providing PDCP duplication. For example, referring to FIG. 8, an example RFS extension 800 in MAC CE for industrial IoT provides “legs” 802 to support duplication of PDCP 800 with up to 4 configured RLC entities 804 for carrier aggregation (CA) and/or for CA plus NR-Dual Connectivity (NR-DC) 806. In an aspect, for example, for CA and/or DC, when defining the radio bearer, the PCDP 800 configuration may be defined, and four RLC 804 configurations may be defined for a device 808 (e.g., a gNB), one for each frequency band that the device 808 may be receiving for CA and/or DC, to provide capacity/throughput of the device 808. If at a point in time it is decided that not all frequency bands are active, a MAC CE may be used to indicate which frequency bands are active.

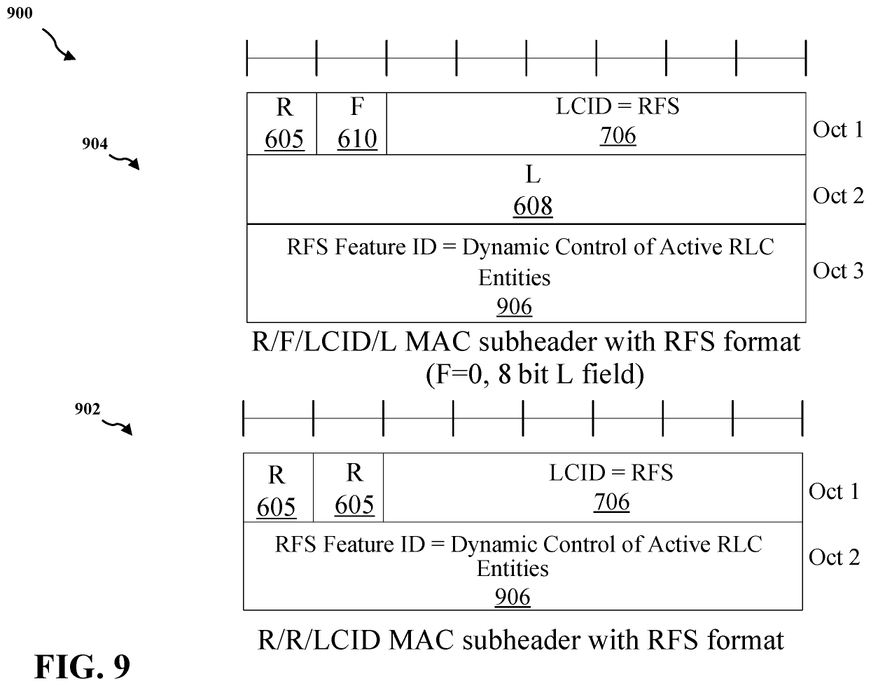

For example, referring to FIG. 9, an aspect provides MAC sub-header formats 900 including an R/R/LCID MAC sub-header with RFS format 902 or an R/F/LCID/L MAC sub-header with RFS format 904 that include dynamic leg selection, thus supporting dynamic selection of active RLC entities from the configured RLC entities. Further, an aspect may provide MAC CE RFS extension for dynamic control of active RLC entities (assuming RAN2 agreement). For example, when the LCID value is equal to RFS 706, the RFS feature ID value may indicate dynamic control of active RLC entities 906.

Some aspects provide definitions in TS 38.321. Table 1 provides an example aspect of LCID for DL-SCH, applicable to Table 6.2.1-1 of TS 38.321.

TABLE 1
An example aspect of LCID for DL-SCH

| Index | LCID values |
|---|---|
| . . . | . . . |
| XX (e.g. 70) | RFS |

Further, an aspect defines RFS formats. Table 2 provides an example aspect of IoT specific feature ID, applicable to Table 6.2.X.1-1 of TS 38.321.

TABLE 2
An example aspect of IoT specific feature ID

| RFS Feature ID | Feature |
|---|---|
| . . . | . . . |
| YY (e.g. 03H) | Dynamic control of active |
| | RLC entities |

Further, an aspect defines formats for MAC CE for dynamic control of active RLC entities.

Optionally, an aspect may provide one value for extension, such as one LCID=RFS ID, e.g., one LCID value indicating RFS. In this case, the RFS feature ID octet provides the next level of hierarchy (e.g., 256 values).

Optionally, an alternative and/or additional aspect may provide one LCID value per Release extension. For example, in an aspect, LCID x=Rel-16 RFS (e.g., the RFS feature ID octet is used for additional MAC CE formats introduced in Rel-16), LCID y=Rel-17 RFS (e.g., the RFS Feature ID octet is used for additional MAC CE formats introduced in Rel-17), etc.

Optionally, an alternative and/or additional may provide one LCID value per vertical extension. For example, in an aspect, LCID x=I-IoT related extensions, LCID y=Multicast/Broadcast related extensions, LCID z=MIMO related extension, etc.

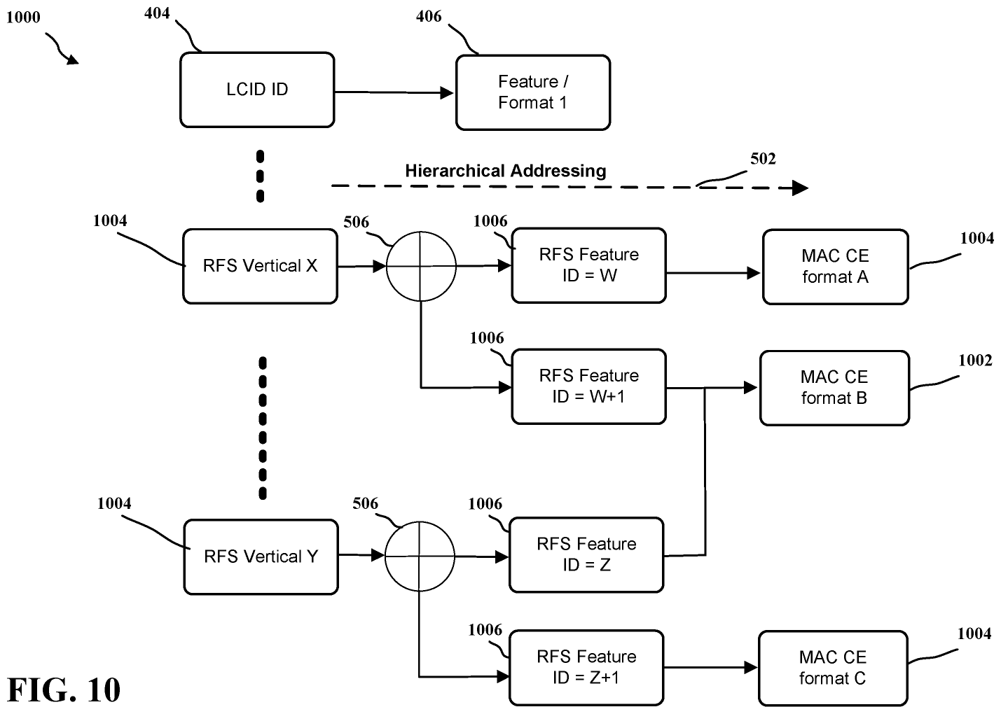

Referring to FIG. 10, in an optional aspect, an example addressing space 1000 provides MAC CE formats 1006. The example addressing space 1000 includes hierarchical addressing 502 and provides one value per vertical extension, where two or more verticals may use a same MAC CE format 1002. For example, multiple combinations of LCID ID (RFS X) 1004 and RFS feature ID 1006 may refer to the same MAC CE format 1002. Accordingly, this aspect separates the identifiers between verticals, while allowing multiple verticals to use same MAC CE formats 1002 or features. In an aspect, the RFS feature ID 1006 is 8 bits long, thus allowing for the above functionality.

In an aspect for example, a method is provided for identifying in a message header the type of a message in a hierarchical manner by including a first identifier field (e.g., LCID) of a determined length, where one or more values fully identify the message type, and one or more values indicate the inclusion of a subsequent extension of the identifier. In an aspect, each extension field includes one or more values which together with previous identifier fields fully identify the message type, and zero or more values which indicate the inclusion of another subsequent extension of the identifier.

In an aspect, for each identifier field value indicating the inclusion of another subsequent identifier field, such identifier field also indicates a set of message types.

In an aspect, extending LCID value space in MAC sub-header may include waiting until running out of LCID values and extending the LCID value space when that time comes. However, extension of LCID value space may increase the MAC sub-header size, thus increasing signaling overhead. An amount of non-extended LCID values may be left reserved in case in later releases there is a need to define additional MAC CE formats for features that use the MAC CE frequently, causing additional overhead.

Therefore, some present aspects may include defining a mechanism to extend the MAC sub-header to increase the LCID value space in Rel-16. Some aspects may identify which additional MAC CE formats should be defined with the extended LCID value space in Rel-16 (and later releases), e.g., MAC CEs that are not likely to be used frequently, or that apply to a specific scenario or vertical. Some aspects may identify whether additional MAC CE formats should be defined without the extended LCID value space in Rel-16 (and later releases), e.g., because of the additional overhead due to expected frequent use of the additional MAC CE formats. Some aspects may identify which additional MAC CE formats should use the additionally defined extended LCID value space and which MAC CE formats should not use the additionally defined extended LCID value space, on a case by case basis.

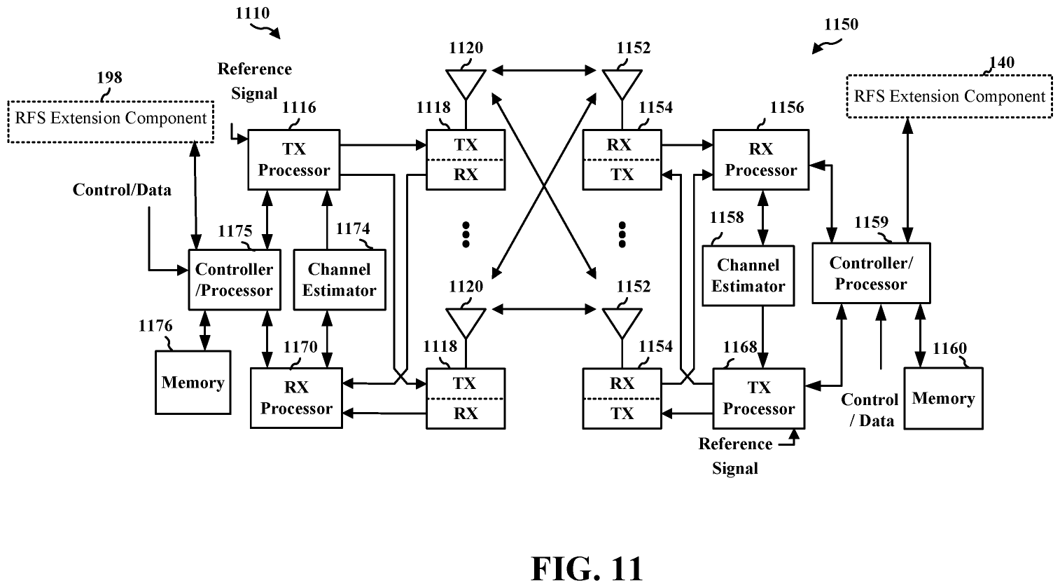

FIG. 11 is a block diagram of a base station 1110 including an RFS extension component 198 in communication with a UE 1150 including an RFS extension component 140 in an access network, where the base station 1110 may be an example implementation of base station 102 and where UE 1150 may be an example implementation of UE 104. In the DL, IP packets from the EPC 160 may be provided to a controller/processor 1175. The controller/processor 1175 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 1175 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/ decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 1116 and the receive (RX) processor 1170 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 1116 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 1174 may be used to determine the coding and modulation scheme, as well as for spatial processing. The channel estimate may be derived from a reference signal and/or channel condition feedback transmitted by the UE 1150. Each spatial stream may then be provided to a different antenna 1120 via a separate transmitter 1118TX. Each transmitter 1118TX may modulate an RF carrier with a respective spatial stream for transmission.

At the UE 1150, each receiver 1154RX receives a signal through its respective antenna 1152. Each receiver 1154RX recovers information modulated onto an RF carrier and provides the information to the receive (RX) processor 1156. The TX processor 1168 and the RX processor 1156 implement layer 1 functionality associated with various signal processing functions. The RX processor 1156 may perform spatial processing on the information to recover any spatial streams destined for the UE 1150. If multiple spatial streams are destined for the UE 1150, they may be combined by the RX processor 1156 into a single OFDM symbol stream. The RX processor 1156 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 1110. These soft decisions may be based on channel estimates computed by the channel estimator 1158. The soft decisions are then decoded and deinterleaved to recover the data and control signals that were originally transmitted by the base station 1110 on the physical channel. The data and control signals are then provided to the controller/processor 1159, which implements layer 3 and layer 2 functionality.

The controller/processor 1159 can be associated with a memory 1160 that stores program codes and data. The memory 1160 may be referred to as a computer-readable medium. In the UL, the controller/processor 1159 provides demultiplexing between transport and logical channels, packet reassembly, deciphering, header decompression, and control signal processing to recover IP packets from the EPC 160. The controller/processor 1159 is also responsible for error detection using an ACK and/or NACK protocol to support HARQ operations.

Similar to the functionality described in connection with the DL transmission by the base station 1110, the controller/processor 1159 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 1158 from a reference signal or feedback transmitted by the base station 1110 may be used by the TX processor 1168 to select the appropriate coding and modulation schemes, and to facilitate spatial processing. The spatial streams generated by the TX processor 1168 may be provided to different antenna 1152 via separate transmitters 1154TX. Each transmitter 1154TX may modulate an RF carrier with a respective spatial stream for transmission.

The UL transmission is processed at the base station 1110 in a manner similar to that described in connection with the receiver function at the UE 1150. Each receiver 1118RX receives a signal through its respective antenna 1120. Each receiver 1118RX recovers information modulated onto an RF carrier and provides the information to a RX processor 1170.

The controller/processor 1175 can be associated with a memory 1176 that stores program codes and data. The memory 1176 may be referred to as a computer-readable medium. In the UL, the controller/processor 1175 provides demultiplexing between transport and logical channels, packet reassembly, deciphering, header decompression, control signal processing to recover IP packets from the UE 1150. IP packets from the controller/processor 1175 may be provided to the EPC 160. The controller/processor 1175 is also responsible for error detection using an ACK and/or NACK protocol to support HARQ operations.

At least one of the TX processor 1168, the RX processor 1156, and the controller/processor 1159 may be configured to perform aspects in connection with the RFS extension component 140 of FIG. 1.

At least one of the TX processor 1116, the RX processor 1170, and the controller/processor 1175 may be configured to perform aspects in connection with the RFS extension component 198 of FIG. 1.

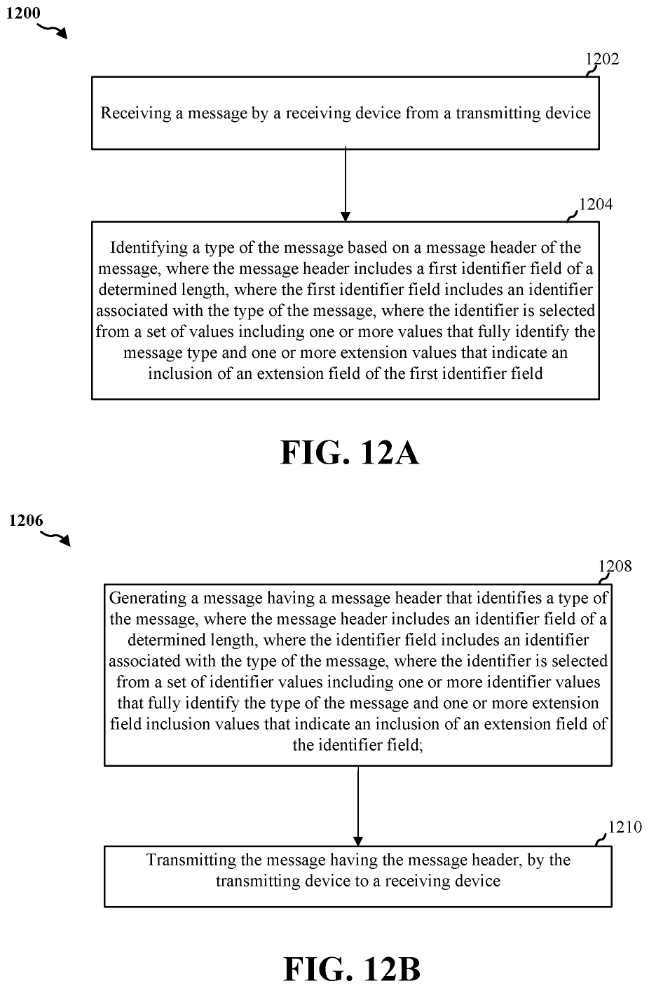

FIGS. 12A and 12B are flowcharts of methods 1200 and 1206 of wireless communication. In an aspect, method 1200 may be performed by a receiving device, which may be a UE (e.g., the UE 104 or 1150, which may include the memory 1160 and which may be the entire UE 104 or 1150 or a component of the UE 104 or 1150 such as the RFS extension component 140, TX processor 1168, the RX processor 1156, and/or the controller/processor 1159) or a base station (e.g., the base station 102 or 1110, which may include the memory 1176 and which may be the entire base station 102 or 1110 or a component of the base station 102 or 1110 such as the RFS extension component 198, TX processor 1116, the RX processor 1170, and/or the controller/processor 1175). Further, method 1206 may be performed by a transmitting device, which may be a UE (e.g., the UE 104 or 1150, which may include the memory 1160 and which may be the entire UE 104 or 1150 or a component of the UE 104 or 1150 such as the RFS extension component 140, TX processor 1168, the RX processor 1156, and/or the controller/processor 1159) or a base station (e.g., the base station 102 or 1110, which may include the memory 1176 and which may be the entire base station 102 or 1110 or a component of the base station 102 or 1110 such as the RFS extension component 198, TX processor 1116, the RX processor 1170, and/or the controller/processor 1175).

Referring to FIG. 12A, at 1202, the method 1200 of wireless communication by a receiving device includes receiving a message by the receiving device from a transmitting device. For example, in an aspect where the receiving device is the UE 104 and the transmitting device is the base station 102, the RFS extension component 140, the TX processor 1168, and/or the controller/processor 1159 may receive a message by the receiving device from a transmitting device. Accordingly, in an aspect where the receiving device is the UE 104 and the transmitting device is the base station 102, the RFS extension component 140, the TX processor 1168, and/or the controller/processor 1159 may provide means for receiving a message by the receiving device from a transmitting device. Further, in an aspect where the receiving device is the base station 102 and the transmitting device is the UE 104, the base station 102 or 1110, the RFS extension component 198, the RX processor 1170, and/or the controller/processor 1175 may receive a message by the receiving device from a transmitting device. Accordingly, the base station 102 or 1110, the RFS extension component 198, the RX processor 1170, and/or the controller/processor 1175 may provide means for receiving a message by the receiving device from a transmitting device.

At 1204, the method 1200 includes identifying a type of the message based on a message header of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. For example, in an aspect where the receiving device is the UE 104 and the transmitting device is the base station 102, the RFS extension component 140, the TX processor 1168, and/or the controller/processor 1159 may identify a type of the message based on a message header of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Accordingly, the UE 104, the RFS extension component 140, the TX processor 1168, and/or the controller/processor 1159 may provide means for identifying a type of the message based on a message header of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Further, in an aspect where the receiving device is the base station 102 and the transmitting device is the UE 104, the base station 102 or 1110, the RFS extension component 198, the RX processor 1170, and/or the controller/processor 1175 may identify a type of the message based on a message header of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Accordingly, the base station 102 or 1110, the RFS extension component 198, the RX processor 1170, and/or the controller/processor 1175 may provide means for identifying a type of the message based on a message header of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field.

Optionally, each of the one or more extension field inclusion values indicates a set of message types.

Optionally, the set of message types corresponds to an RFS, a vertical or a release in a standard, a vendor specific enhancement, or an operator specific enhancement.

Optionally, the vertical includes a cellular IoT feature or an industrial IoT feature.

Optionally, the RFS includes a MIMO enhancement or a power saving enhancement.

Optionally, the extension field includes an extension identifier selected from a set of extension identifier values.

Optionally, the set of extension identifier values includes one or more extension identifier values that each, together with the identifier, fully identify the type of the message.

Optionally, the set of extension identifier values includes one or more subsequent extension field inclusion values that indicate a further inclusion of a subsequent extension field of the extension field of the identifier field.

Optionally, each of the one or more subsequent extension field inclusion values indicates a set of message types.

Optionally, the receiving device is a UE and the transmitting device is a base station.

Optionally, the transmitting device is a UE and the receiving device is a base station.

Referring to FIG. 12B, at 1208, the method 1206 of wireless communication by a transmitting device includes generating a message having a message header that identifies a type of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. For example, in an aspect where the receiving device is the UE 104 and the transmitting device is the base station 102, the RFS extension component 140, the TX processor 1168, and/or the controller/processor 1159 may generate a message having a message header that identifies a type of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Accordingly, in an aspect where the receiving device is the UE 104 and the transmitting device is the base station 102, the RFS extension component 140, the TX processor 1168, and/or the controller/processor 1159 may provide means for generating a message having a message header that identifies a type of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Further, in an aspect where the receiving device is the base station 102 and the transmitting device is the UE 104, the base station 102 or 1110, the RFS extension component 198, the RX processor 1170, and/or the controller/processor 1175 may generate a message having a message header that identifies a type of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field. Accordingly, the base station 102 or 1110, the RFS extension component 198, the RX processor 1170, and/or the controller/processor 1175 may provide means for generating a message having a message header that identifies a type of the message, where the message header includes an identifier field of a determined length, where the identifier field includes an identifier associated with the type of the message, where the identifier is selected from a set of identifier values including one or more identifier values that fully identify the type of the message and one or more extension field inclusion values that indicate an inclusion of an extension field of the identifier field.

At 1210, the method 1206 includes transmitting the message having the message header, by the transmitting device to a receiving device. For example, in an aspect where the receiving device is the UE 104 and the transmitting device is the base station 102, the RFS extension component 140, the TX processor 1168, and/or the controller/processor 1159 may transmit the message having the message header, by the transmitting device to a receiving device. Accordingly, the UE 104, the RFS extension component 140, the TX processor 1168, and/or the controller/processor 1159 may provide means for transmitting the message having the message header, by the transmitting device to a receiving device. Further, in an aspect where the receiving device is the base station 102 and the transmitting device is the UE 104, the base station 102 or 1110, the RFS extension component 198, the RX processor 1170, and/or the controller/processor 1175 may transmit the message having the message header, by the transmitting device to a receiving device. Accordingly, the base station 102 or 1110, the RFS extension component 198, the RX processor 1170, and/or the controller/processor 1175 may provide means for transmitting the message having the message header, by the transmitting device to a receiving device.

Optionally, each of the one or more extension field inclusion values indicates a set of message types.

Optionally, the set of message types corresponds to an RFS, a vertical or a release in a standard, a vendor specific enhancement, or an operator specific enhancement.

Optionally, the vertical includes a cellular IoT feature or an industrial IoT feature.

Optionally, the RFS includes a MIMO enhancement or a power saving enhancement.

Optionally, the extension field includes an extension identifier selected from a set of extension identifier values.

Optionally, the set of extension identifier values includes one or more extension identifier values that each, together with the identifier, fully identify the type of the message.

Optionally, the set of extension identifier values includes one or more subsequent extension field inclusion values that indicate a further inclusion of a subsequent extension field of the extension field of the identifier field.

Optionally, each of the one or more subsequent extension field inclusion values indicates a set of message types.

Optionally, the receiving device is a UE and the transmitting device is a base station.

Optionally, the transmitting device is a UE and the receiving device is a base station.

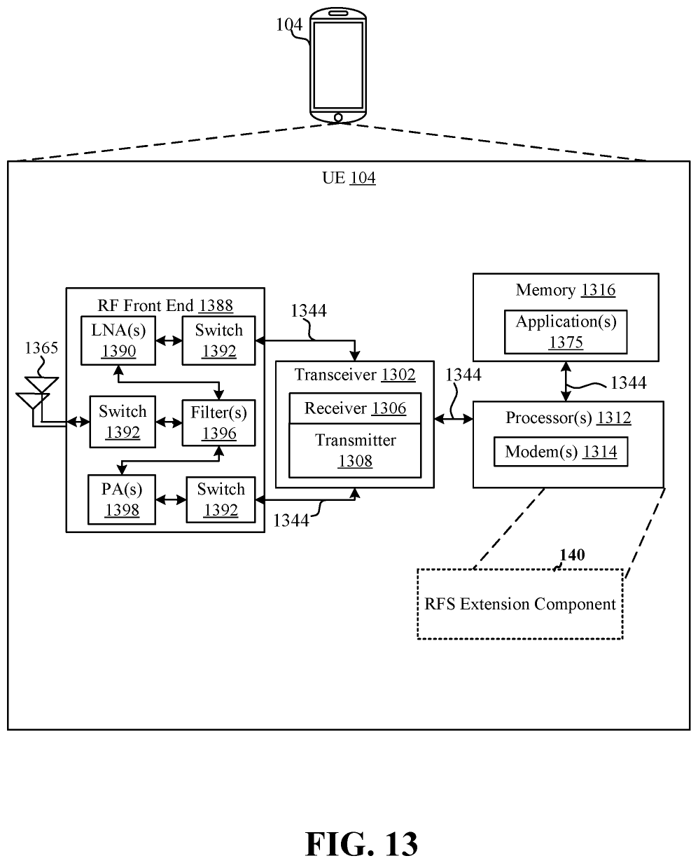

Referring to FIG. 13, one example of an implementation of UE 104 may include a variety of components, some of which have already been described above, but including components such as one or more processors 1312 and memory 1316 and transceiver 1302 in communication via one or more buses 1344, which may operate in conjunction with modem 1314, and RFS extension component 140 to enable one or more of the functions described herein related to RFS extension. Further, the one or more processors 1312, modem 1314, memory 1316, transceiver 1302, RF front end 1388 and one or more antennas 1365 may be configured to support voice and/or data calls (simultaneously or non-simultaneously) in one or more radio access technologies. The antennas 1365 may include one or more antennas, antenna elements, and/or antenna arrays.

In an aspect, the one or more processors 1312 may include a modem 1314 that uses one or more modem processors. The various functions related to RFS extension component 140 may be included in modem 1314 and/or processors 1312 and, in an aspect, may be executed by a single processor, while in other aspects, different ones of the functions may be executed by a combination of two or more different processors. For example, in an aspect, the one or more processors 1312 may include any one or any combination of a modem processor, or a baseband processor, or a digital signal processor, or a transmit processor, or a receiver processor, or a transceiver processor associated with transceiver 1302. In other aspects, some of the features of the one or more processors 1312 and/or modem 1314 associated with RFS extension component 140 may be performed by transceiver 1302.

Also, memory 1316 may be configured to store data used herein and/or local versions of applications 1375, RFS extension component 140 and/or one or more of subcomponents thereof being executed by at least one processor 1312. Memory 1316 may include any type of computer-readable medium usable by a computer or at least one processor 1312, such as random access memory (RAM), read only memory (ROM), tapes, magnetic discs, optical discs, volatile memory, non-volatile memory, and any combination thereof. In an aspect, for example, memory 1316 may be a non-transitory computer-readable storage medium that stores one or more computer-executable codes defining RFS extension component 140 and/or one or more of subcomponents thereof, and/or data associated therewith, when UE 104 is operating at least one processor 1312 to execute RFS extension component 140 and/or one or more subcomponents thereof.

Transceiver 1302 may include at least one receiver 1306 and at least one transmitter 1308. Receiver 1306 may include hardware, firmware, and/or software code executable by a processor for receiving data, the code including instructions and being stored in a memory (e.g., computer-readable medium). Receiver 1306 may be, for example, a radio frequency (RF) receiver. In an aspect, receiver 1306 may receive signals transmitted by at least one base station 102. Additionally, receiver 1306 may process such received signals, and also may obtain measurements of the signals, such as, but not limited to, Ec/Io, signal-to-noise ratio (SNR), reference signal received power (RSRP), received signal strength indicator (RSSI), etc. Transmitter 1308 may include hardware, firmware, and/or software code executable by a processor for transmitting data, the code including instructions and being stored in a memory (e.g., computer-readable medium). A suitable example of transmitter 1308 may including, but is not limited to, an RF transmitter.

Moreover, in an aspect, UE 104 may include RF front end 1388, which may operate in communication with one or more antennas 1365 and transceiver 1302 for receiving and transmitting radio transmissions, for example, wireless communications transmitted by at least one base station 102 or wireless transmissions transmitted by UE 104. RF front end 1388 may be connected to one or more antennas 1365 and may include one or more low-noise amplifiers (LNAs) 1390, one or more switches 1392, one or more power amplifiers (PAs) 1398, and one or more filters 1396 for transmitting and receiving RF signals.

In an aspect, LNA 1390 may amplify a received signal at a desired output level. In an aspect, each LNA 1390 may have a specified minimum and maximum gain values. In an aspect, RF front end 1388 may use one or more switches 1392 to select a particular LNA 1390 and its specified gain value based on a desired gain value for a particular application.

Further, for example, one or more PA(s) 1398 may be used by RF front end 1388 to amplify a signal for an RF output at a desired output power level. In an aspect, each PA 1398 may have specified minimum and maximum gain values. In an aspect, RF front end 1388 may use one or more switches 1392 to select a particular PA 1398 and its specified gain value based on a desired gain value for a particular application.

Also, for example, one or more filters 1396 may be used by RF front end 1388 to filter a received signal to obtain an input RF signal. Similarly, in an aspect, for example, a respective filter 1396 may be used to filter an output from a respective PA 1398 to produce an output signal for transmission. In an aspect, each filter 1396 may be connected to a specific LNA 1390 and/or PA 1398. In an aspect, RF front end 1388 may use one or more switches 1392 to select a transmit or receive path using a specified filter 1396, LNA 1390, and/or PA 1398, based on a configuration as specified by transceiver 1302 and/or processor 1312.

As such, transceiver 1302 may be configured to transmit and receive wireless signals through one or more antennas 1365 via RF front end 1388. In an aspect, transceiver 1302 may be tuned to operate at specified frequencies such that UE 104 can communicate with, for example, one or more base stations 102 or one or more cells associated with one or more base stations 102. In an aspect, for example, modem 1314 may configure transceiver 1302 to operate at a specified frequency and power level based on the UE configuration of the UE 104 and the communication protocol used by modem 1314.

In an aspect, modem 1314 may be a multiband-multimode modem, which can process digital data and communicate with transceiver 1302 such that the digital data is sent and received using transceiver 1302. In an aspect, modem 1314 may be multiband and be configured to support multiple frequency bands for a specific communications protocol. In an aspect, modem 1314 may be multimode and be configured to support multiple operating networks and communications protocols. In an aspect, modem 1314 may control one or more components of UE 104 (e.g., RF front end 1388, transceiver 1302) to enable transmission and/or reception of signals from the network based on a specified modem configuration. In an aspect, the modem configuration may be based on the mode of the modem and the frequency band in use. In another aspect, the modem configuration may be based on UE configuration information associated with UE 104 as provided by the network during cell selection and/or cell reselection.

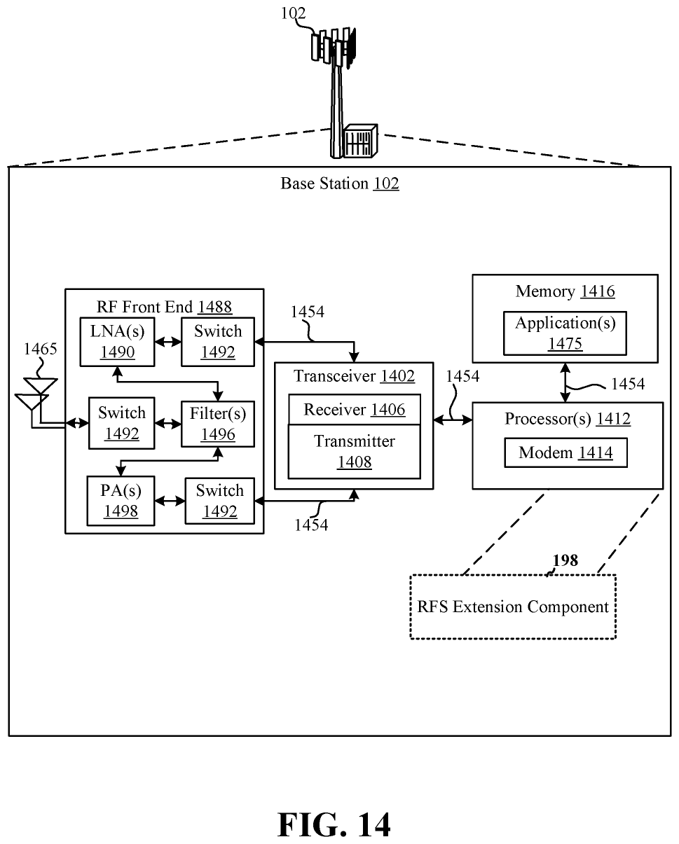

Referring to FIG. 14, one example of an implementation of base station 102 may include a variety of components, some of which have already been described above, but including components such as one or more processors 1412 and memory 1416 and transceiver 1402 in communication via one or more buses 1454, which may operate in conjunction with modem 1414 and RFS extension component 198 to enable one or more of the functions described herein related to RFS extension.

The transceiver 1402, receiver 1406, transmitter 1408, one or more processors 1412, memory 1416, applications 1475, buses 1454, RF front end 1488, LNAs 1490, switches 1492, filters 1496, PAs 1498, and one or more antennas 1465 may be the same as or similar to the corresponding components of UE 104, as described above, but configured or otherwise programmed for base station operations as opposed to UE operations.

Several aspects of telecommunication systems have been presented with reference to various apparatus and methods. These apparatus and methods have been described in the above detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a receiving device, comprising:
receiving a message by the receiving device from a transmitting device; and
identifying a type of the message based on a message header of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field.

2. The method of claim 1, wherein each of the one or more extension field inclusion values indicates a set of message types.

3. The method of claim 2, wherein the set of message types corresponds to a RAN feature set, a vertical or a release in a standard, a vendor specific enhancement, or an operator specific enhancement.

4. The method of claim 3, wherein the vertical includes a cellular IoT feature or an industrial IoT feature.

5. The method of claim 3, wherein the RAN feature set includes a MIMO enhancement or a power saving enhancement.

6. The method of claim 1, wherein the extension field includes an extension identifier selected from a set of extension identifier values.

7. The method of claim 6, wherein the set of extension identifier values includes one or more extension identifier values that each, together with the identifier, fully identify the type of the message.

8. The method of claim 1, wherein the set of extension identifier values includes one or more subsequent extension field inclusion values that indicate a further inclusion of a subsequent extension field of the extension field of the identifier field.

9. The method of claim 8, wherein each of the one or more subsequent extension field inclusion values indicates a set of message types.

10. The method of claim 1, wherein the receiving device is a user equipment (UE) and the transmitting device is a base station.

11. The method of claim 1, wherein the transmitting device is a user equipment (UE) and the receiving device is a base station.

12. A receiving device for wireless communication, comprising:
a memory; and
at least one processor coupled with the memory and configured to:
receive a message by the receiving device from a transmitting device; and
identify a type of the message based on a message header of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field.

13. The receiving device of claim 12, wherein each of the one or more extension field inclusion values indicates a set of message types.

14. The receiving device of claim 13, wherein the set of message types corresponds to a RAN feature set, a vertical or a release in a standard, a vendor specific enhancement, or an operator specific enhancement.

15. A method of wireless communication by a transmitting device, comprising:
generating a message having a message header that identifies a type of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field; and
transmitting the message having the message header, by the transmitting device to a receiving device.

16. The method of claim 15, wherein each of the one or more extension field inclusion values indicates a set of message types.

17. The method of claim 16, wherein the set of message types corresponds to a RAN feature set, a vertical or a release in a standard, a vendor specific enhancement, or an operator specific enhancement.

18. The method of claim 17, wherein the vertical includes a cellular IoT feature or an industrial IoT feature.

19. The method of claim 17, wherein the RAN feature set includes a MIMO enhancement or a power saving enhancement.

20. The method of claim 15, wherein the extension field includes an extension identifier selected from a set of extension identifier values.

21. The method of claim 20, wherein the set of extension identifier values includes one or more extension identifier values that each, together with the identifier, fully identify the type of the message.

22. The method of claim 15, wherein the set of extension identifier values includes one or more subsequent extension field inclusion values that indicate a further inclusion of a subsequent extension field of the extension field of the identifier field.

23. The method of claim 22, wherein each of the one or more subsequent extension field inclusion values indicates a set of message types.

24. The method of claim 15, wherein the receiving device is a user equipment (UE) and the transmitting device is a base station.

25. The method of claim 15, wherein the transmitting device is a user equipment (UE) and the receiving device is a base station.

26. A transmitting device for wireless communication, comprising:
a memory; and
at least one processor coupled with the memory and configured to:
generate a message having a message header that identifies a type of the message, wherein the message header includes an identifier field of a determined length, wherein the identifier field includes an identifier associated with the type of the message, wherein the identifier is selected from a set of identifier values including one or more identifier values that fully identify the type of the message and one or more extension field inclusion values that indicate an inclusion of an extension field of the identifier field; and
transmit the message having the message header, by the transmitting device to a receiving device.

27. The transmitting device of claim 26, wherein each of the one or more extension field inclusion values indicates a set of message types.

28. The transmitting device of claim 27, wherein the set of message types corresponds to a RAN feature set, a vertical or a release in a standard, a vendor specific enhancement, or an operator specific enhancement.

29. The transmitting device of claim 28, wherein the vertical includes a cellular IoT feature or an industrial IoT feature.

30. The transmitting device of claim 28, wherein the RAN feature set includes a MIMO enhancement or a power saving enhancement.
